(19) United States
(12) Patent Application Publication
(10) Pub. No.: US 2008/0028148 A1
(43) Pub. Date: Jan. 31, 2008

(54) Integrated memory device and method of operating a memory device

(76) Inventors: Paul Wallner, Prien (DE); Chaitanya Dudha, Muenchen (DE)

Correspondence Address: SLATER & MATSIL LLP, 17950 PRESTON ROAD, SUITE 1000, DALLAS, TX, 75252, US

(21) Appl. No.: 11/496,261

(22) Filed: Jul. 31, 2006

(51) Int. Cl. G06F 12/00

(52) U.S. Cl. 711/118

(57) ABSTRACT

An integrated memory device includes a memory core having a plurality of memory cells and a group of terminals for communication between the memory device and an external electronic device. A data buffer temporarily stores data. The data buffer is coupled to the group of terminals and to the memory core. The data buffer includes a plurality of data buffer sections. Each data buffer section is capable of temporarily storing at least one data frame and being accessible by a respective data buffer address. A data buffer control unit is also provided.

### TECHNICAL FIELD

The present invention relates to the field of memory devices, their manufacture and their operation.

### BACKGROUND

Integrated memory devices, for instance volatile memory devices like DRAMs, comprise a memory core in which a plurality of memory cells is provided. The memory cells serve for storage of digital information. In case of volatile memories like DRAMs, storage of data in the memory cells requires maintaining the operation voltage of the memory device in order to allow repeated refresh of the data stored in the memory core in volatile manner.

Memory devices like DRAMs or other volatile memory devices may be integrated in a memory module, a motherboard, in a handy or cellular phone, for instance, or in any other electronic device.

Integrated memory devices may further comprise a plurality of terminals (that is electrical contact structures) for communication with other devices, for instance with a superior electronic component and/or with a memory controller. The terminals may be formed as contact pins, contact surfaces or bond pads, for instance. They may also be formed in any other shape. The group of terminals serves to receive data destined for the memory device or to output data supplied by the memory device. Unidirectional as well as bidirectional interconnects may be connected to the terminals of the memory device internally or externally.

In conventional memory devices, like DRAMs for instance, data to be stored in the memory core are received via the terminals of the memory device and are internally directed to the memory core for volatile storage within the memory cells. Similarly, also in other memory devices data to be stored in a memory core are directly forwarded from the terminals to the memory core for storage without intermediate storage. Typically, the memory core comprises a memory array and a decoder circuit region for accessing and operating the memory array. The memory array inter alia comprises a plurality of memory cells connected to wordlines and bitlines. The decoder circuit region comprises further components enabling operation of the memory array and in particular enabling read and write operations, for instance.

Accordingly, the present invention in particular refers to any kind of memory device comprising a memory core including a (for instance bank-organized) memory cell array as well as address decoding means. The address decoding means serve for decoding an address code derived from a signal frame decoder. The signal frame decoder may receive signal frames from a reception interface section. The reception interface section may comprise the plurality of terminals. The memory device may comprise at least one memory bank and may be configured for writing and/or reading data in/from at least one memory bank of the memory cell array. The memory device in particular may be configured to execute write/read operations in accordance with write/read commands that are contained within one or more signal frames. For instance, the memory device may be configured to execute write commands and/or commands that each may be spread over a plurality of signal frames.

Future generations of memory devices like DRAMs perhaps might give rise to an intermediate storage of data destined for a memory core. It might become advisable to intermediately store data received at the terminals of a memory device and destined for the memory core of the memory device, in a separate data buffer from which the data are transmitted to the memory core. It might further become advisable to temporarily store data read from the memory device in an intermediate data buffer before supplying them via the terminals to an external electronic device. In both cases an intermediate data buffer might be provided for improved communication and data management. Apart from read data or write data to be read from the memory core or to be written into a memory core, further data, like command data or control data might be stored intermediately, for instance. These further data might be forwarded within data frames that represent groups of predefined format for groupwise or data frame-wise transmission and reception of data.

In case of communication and data exchange with a memory device comprising, in addition to the memory core, a data buffer for intermediate storage, it might become advisable to access the data buffer addresses of the data buffer and to attribute, to the data destined for intermediate storage in the data buffer, the addresses within the data buffer in which the data shall be stored. This would require generation of address data that could be generated and transmitted in addition to the actual data (like write data, read data or command data).

Since generation and transmission of additional data for addressing an intermediate data buffer would enlarge the efforts, costs and time for data communication, there might arise the need to operate and communicate with a memory device without externally generating and providing additional data buffer addresses and to simplify internal data transmission within a memory device.

### SUMMARY OF THE INVENTION

One exemplary embodiment of the present invention provides an integrated memory device including a memory core having a plurality of memory cells, a group of terminals for communication between the memory device and an external electronic device. The device also includes a data buffer for temporary storage of data. The data buffer is connected to the group of terminals and to the memory core, and includes a plurality of data buffer sections. Each data buffer section is capable of temporarily storing at least one data frame and is accessible by a respective data buffer address. A data buffer control unit is provided, wherein the memory device is constructed to generate, for each data buffer section, at least one data bit assigned to the respective data buffer section. The data bit indicates whether with the respective data buffer section includes empty data buffer area for storing at least one data frame or whether the respective data buffer section is occupied. The data buffer control unit is constructed to calculate, using the data bits assigned to the data buffer sections, a data buffer address of a data buffer section to which data frames are transmitted for being stored temporarily.

Another exemplary embodiment of the invention provides a method of operating a memory device including a data buffer having a plurality of data buffer sections accessible by data buffer addresses. Each data buffer section is assigned to a data buffer address. The data buffer addresses are represented by data buffer address numbers and the data buffer address numbers of the data buffer sections constitute a predefined order of data buffer address numbers. At least one data bit assigned to the respective data buffer section is generated for each data buffer section. The data bits indicate whether the respective data buffer section includes empty data buffer area for storing at least one data frame or whether the respective data buffer section is occupied. The data bits are combined with one another, thereby calculating a data buffer address number that represents, within the predefined order of data buffer address numbers, a first data buffer address number corresponding to a data buffer section that comprises empty data buffer area for storing at least one data frame.

The invention refers to any kind of memory device. One possible field of the invention is a DRAM memory device, for instance. Another possible field of the invention are future generations of memory devices having protocol base architectures. The invention further refers to the field of communication with memory devices and data processing within memory devices. The present invention further refers to the field of volatile memory devices.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a schematical top view on an embodiment of an integrated memory device;

FIGS. 2 to 5 illustrate an exemplary embodiment of a method according to the invention;

FIG. 6 illustrates a further example of the method of the embodiment of FIGS. 2 to 5; and

FIGS. 7 to 10 illustrate an alternative embodiment of a method according to the invention.

The following list of reference symbols can be used in conjunction with the figures:
1 memory device
2 terminal
3 data frame decoder
4 data buffer
4a input
4b output
5 memory core
10 data buffer section
10′ selected data buffer section
13 input stage
14 output stage
15 memory cell
17, 18, 19 interconnect
25 data buffer control unit
26 address pointer
30 data frame decoder
100 external electronic device
A data buffer address
Am calculated data buffer address
DB; DB′; . . . data bit
L level of hierarchy
M calculated data buffer address number
m data buffer address number
WD; DM data frame

### DETAILED DESCRIPTION OF ILLUSTRATIVE EMBODIMENTS

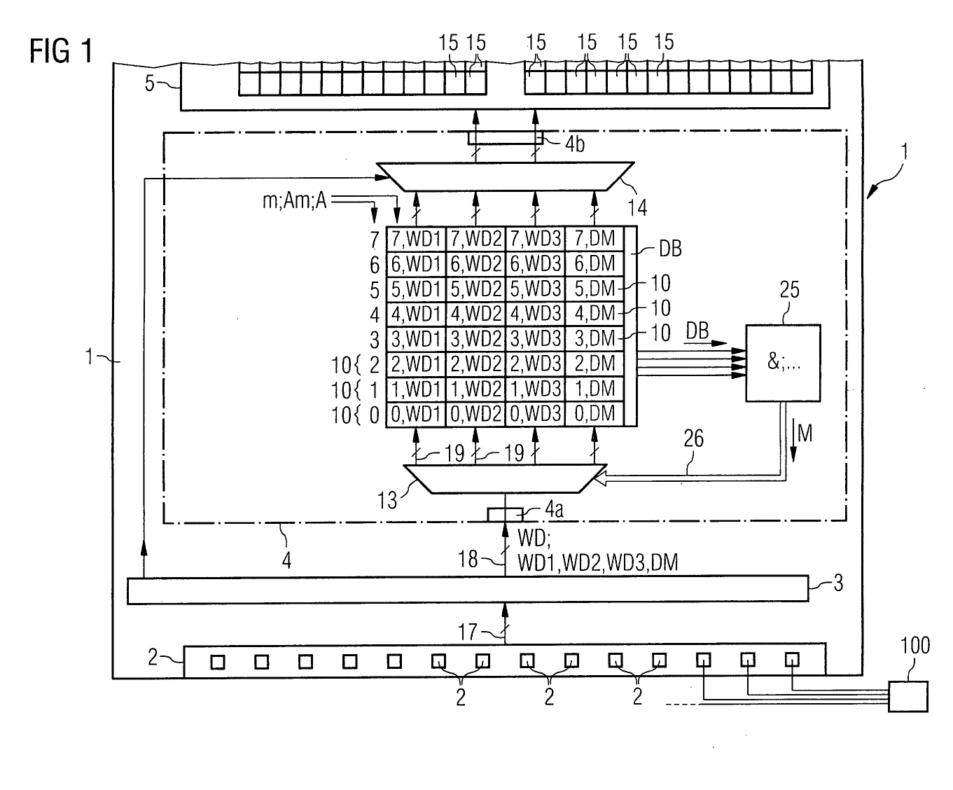

FIG. 1 illustrates a schematical top view on an integrated memory device 1 which may be a volatile memory device. The volatile memory device may be a DRAM (dynamic random access memory), for instance. The memory device 1 comprises a core region, that is a memory core 5 comprising a plurality of memory cells 15. The memory cells 15 may be volatile memory cells comprising a selection transistor and a storage capacity, like a deep trench capacitor or a stacked capacitor. The memory core 5 may be formed on a substrate surface of a substrate. The memory cells 15 may be connected to a plurality of bitlines and to a plurality of wordlines serving for accessing the memory cells 15.

The memory device 1 further comprises a plurality of terminals 2 serving as contact structures for communication of the integrated memory device 1 with an external electronic device 100 schematically illustrated in FIG. 1. The external electronic device 100 may be a memory controller, for instance. It may also be a memory module, a motherboard or any other electronic device or component.

The plurality of terminals 2 may be formed as contact structures, like contact pins, bond pads or planar contact surfaces, for instance. The terminals 2 serve for communication with an external electronic device 100. The terminals 2 enable accessing in the memory device 1 and receiving and/or supplying data. Via conductive lines like interconnects 17, 18, 19 schematically illustrated in FIG. 1, the terminals 2 are connected to the data buffer 4. The data buffer 4 comprises data buffer units, like data buffer sections (which may be, for instance, latches, flip-flops or registers) for temporarily storing data. The data buffer 4 in particular may comprise a plurality of data buffer sections 10, to each data buffer section 10 a respective data buffer address A being assigned. Each data buffer section 10 is capable of storing a plurality of data. In FIG. 1 the data buffer addresses A of the data buffer sections 10 are represented by data buffer address numbers m which, as an example, may range from 0 to 7. Generally, the data buffer address numbers m may range over any arbitrary numerical range or other predefined range of numbers. According to one embodiment the data buffer address numbers for instance may form a plurality of 2ⁿ address numbers, the address numbers preferably ranging from 0 to (2ⁿ−1). The numerical range of address numbers may start with the smallest address number or with the largest address number as the first address number, for instance. In the example of FIG. 1 only eight addresses are illustrated for simplicity of explanation.

The data buffer 4 may comprise an input 4a and an output 4b. The data (like data frames, for instance) may be received at the input 4a of the data buffer 4 for being stored temporarily in the data buffer sections 10. When the stored data are read from the data buffer sections 10, they are output via the output 4b of the data buffer 4. In the example of FIG. 1 the input 4a of the data buffer 4 is connected to the plurality of terminals 2. The output 4b of the data buffer 4 is connected to the memory core 5 in the example of FIG. 1. Alternatively, the input 4a may be connected to the memory core 5 and the output 4b of the data buffer 4 may be connected to the terminals 2. In that alternative embodiment, data received from the memory core 5 are temporarily storable in the data buffer 4. In the embodiment of FIG. 1, however, the input 4a is connected to the terminals 2 for receiving data for intermediate, temporary storage in the data buffer 4. When data stored in the data buffer 4 are to be written into the memory core 5, they are transmitted via the output 4b of the data buffer 4 to the memory core 5.

According to FIG. 1, data, which are received from an external electronic device 100 and entering the memory device 1 via the terminals 2, are temporarily stored in the data buffer 4 prior to writing them into the memory core, for instance. The memory device may comprise a data buffer control unit 25 capable of calculating and supplying a data buffer address number of a data buffer section 10 in which data are to be stored next. The data buffer control unit 25 may be comprised in the data buffer 4. The data buffer control unit 25 may be connected to the plurality of data buffer sections 10 via interconnects. The interconnects in particular may be used to transmit data bits indicating the presence for absence of free data buffer storage area (within the data buffer sections) to the data buffer control unit 25. The data buffer control unit 25 is capable of performing a calculation, for instance by means of Boolean operations like AND-operations, in order to calculate and to supply a calculated data buffer address number M (and/or a data buffer address A) to the entry of the plurality of data buffer sections 10. To this end, the data buffer 4 comprises or is connected to an address pointer 26 transmitting the calculated data buffer address number N or the encrypted data buffer address to which data are to be written next for intermediate, temporary storage. In particular, address signals, command signals and data signals (received from a receiver comprising the terminals) may be input into the data buffer for intermediate storage. These data may be encrypted or non-encrypted. At the output of the data buffer, data signals and data mask signals of a data buffer address (and stored in a plurality of data buffer sections, like a plurality of four data buffer sections) may be output from the data buffer and transmitted to the memory core. When transmitting the data to the memory core, control signals from other components (rather than the data buffer) may be control correct processing and storage of the data within the memory core.

The data buffer 4 may further comprise an input stage 13 and an output stage 14. The input stage 13 may serve to direct the data to be stored to the particular respective data buffer address A received from the data buffer control unit 25 and thus used for storing the data. The output stage 14 may be used for reading data from the data buffer sections 10 and transmitting them via interconnect lines to the output 4b and to the memory area 5 in which the data are to be finally stored (in non-intermediate manner) in the memory cells 15.

The data may be supplied to and received by the memory device 1 in form of data frames WD, like data frames WD1, WD2, WD3 and DM, for instance. The data frames WD1, WD2, WD3 may comprise data to be stored in the memory core 5 after intermediate storage in the data buffer 4. These data frames may also comprise command data or control data representing other information than digital data bits to be stored in the memory cells 15. Some of the data frames may be data mask frames comprising mask data representing protocolled defined information. In particular, those data frames denoted with DM may be data mask frames. The data mask frames DM may, for instance, indicate a group of data frames WD1, WD2, WD3 storable in one data buffer section 10 and may comprise an information that a group of information to be written into the memory core 5 is completed. The data mask frames accordingly contain information indicating the start and the end of a group of data.

All data frames WD are received via the terminals 2 of the memory device 1. The memory device 1 may comprise a data frame decoder 3 serving to decode data frames received via the plurality of terminals 2. The data frame decoder 3 may be used for transmitting the decoded data frames to the input stage 13 and to the data buffer sections 10 of the data buffer 4 and to instruct the output stage 14 to initiate reading from data buffer section and writing into memory core. Since in FIG. 1 all elements illustrated are schematical; alternative embodiments of the memory device, arrangements thereof and connections between them are covered by the present invention as well.

According to an embodiment of the invention, the memory device is capable of generating, for each data buffer section 10, one (or plural) data bit(s) assigned to the respective data buffer section 10, the data bit indicating whether the respective data buffer section 10 comprises empty data buffer area for storing at least one data frame or not (that is whether the respective data buffer section is at least partially empty or otherwise completely occupied). Furthermore, according to this embodiment of the invention, the data buffer control unit is capable of calculating, using the data bits assigned to the data buffer sections, a data buffer address Am of a data buffer section 10 to which data frames (for instance at least one next data frame or a plurality of further next data frames) are transmitted for being stored temporarily. Accordingly, the data buffer control unit 25 is generating data buffer section addresses to which the received data frames are transmitted for intermediate storage. Thereby the plurality of data buffer sections 10 is accessible without the need to generate, externally from the memory device 1, additional address information destined for the intermediate data buffer 4.

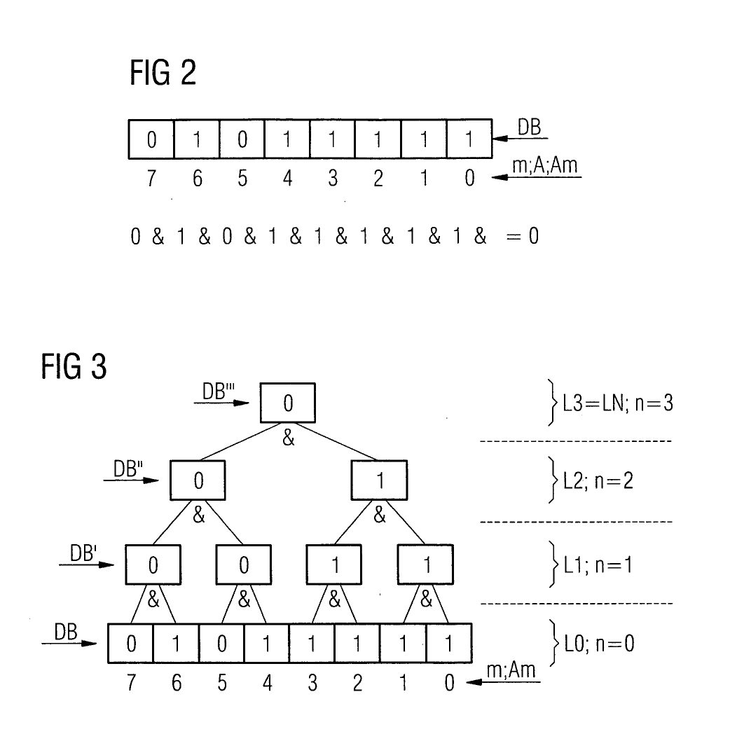

The data buffer control unit 25 is constructed such that it performs a calculation resulting in a data buffer address A or data buffer address number M indicating at which data buffer address (that is in which data buffer section 10) one or plural next data frames are to be stored subsequently. One possible way of performing the calculation is herein below explained with reference to FIGS. 2 to 6. The particular way of performing the calculation is mandatory since further alternative algorithms may be used for calculating the data buffer address M within the data buffer control unit 25. Furthermore, the respective steps of the algorithm of FIGS. 2 to 5 and of the subsequent figures (and of corresponding constructional devices serving for performing the respective steps of the algorithms) need not be present and connected to one another as in the examples of the FIGS. 2 to 5. Instead, alternative constructions of circuits within the data buffer control unit 25 may be used for performing calculation and supplying a resulting, calculated data buffer address number.

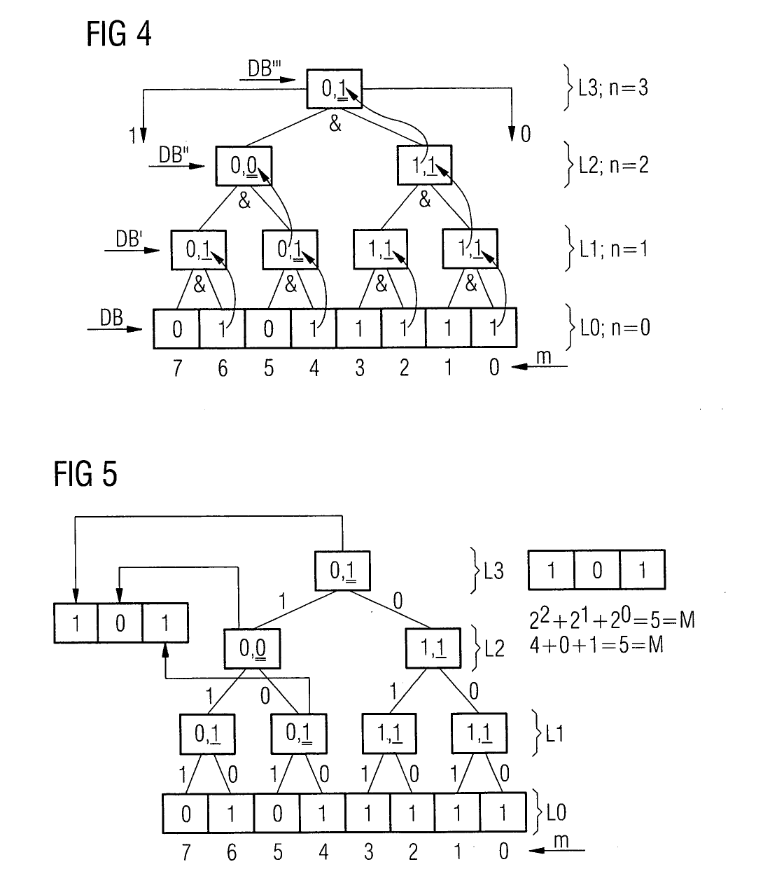

FIGS. 2 to 5 illustrate some aspects or steps of an algorithm of one embodiment of the method of the invention. Whereas FIGS. 2 and 3 illustrate an evaluation whether at least one of the data buffer sections is partially empty and thus provides empty data buffer area for storing at least one data frame, FIGS. 4 and 5 illustrate one exemplary way of calculating a data buffer address number of a data buffer section to which at least one data frame may be sent for intermediate, temporary storage.

FIG. 2 illustrates a plurality of eight data bits DB allocated to a plurality of data buffer address numbers 0, 1, 2, . . . , 7. The data buffer address numbers are represented by the variable m and are corresponding to those address numbers m of addresses A illustrated in FIG. 1. The data buffer sections 10 corresponding to the respective addresses A and the address numbers m are not illustrated in FIG. 2. Instead, data bits DB are indicated in FIG. 2, the data bits DB indicating whether there is any empty area in the corresponding data buffer section 10 of the data buffer address number m which empty area is not yet occupied with digital information to be written into the memory core. In the example of FIG. 2, the data buffer sections having the address numbers 0, 1, 2, 3, 4 and 6 are full and thus are not capable of storing further data frames. Only the data buffer sections of the addresses 5 and 7 comprise empty data buffer area for storing at least one (further) data frame. According to FIG. 2 an integral data bit is calculated by combining the data bits DB of all eight data buffer addresses A with one another by means of AND-operations, resulting in a digital “0” indicating that there is empty storage area in at least one of the data buffer sections. However, the particular address of the respective data buffer section and the calculation of the address, in which data frames to be stored next, will be explained referring to FIGS. 4 and 5.

FIG. 3 schematically illustrates how to calculate the integral data bit of FIG. 2. A similar illustration as in FIG. 3 will be presented in FIGS. 4 and 5 for calculating the data buffer address of a data buffer section comprising empty data buffer area and for illustrating a method of calculating such a data buffer address of the integrated memory device according to the invention.

In FIG. 3 the data bits DB of FIG. 2 are schematically arranged in a lowermost level of hierarchy L0. Below the data bits DB of the first level of hierarchy L0, the data buffer address numbers m ranging from 0 to 7 in reverse order are indicated. The algorithm of the embodiment of the invention comprises combining two respective data bits DB of the first level of hierarchy L0 with one another by means of AND-operations, thereby resulting in one respective data bit DB′ of a further level of hierarchy L1 of the order n=1. Accordingly, the first order data bits DB′ resulting from data bits DB 4 to 7 both are “0” since the data buffer sections having the data buffer address numbers 5 and 7 are at least partially empty. In a further level of hierarchy L2 of the order n=2, two respective data bits DB′ of the level L1 are combined with one another by further AND-operations, thereby obtaining one respective data bit DB″ of the level L2. Finally, the data bits DB″ of the level of hierarchy L2 are combined with one another to yield one data bit DB′″ of a third, ultimate level of hierarchy L3 of the order n=3. FIG. 3 thus indicates how to obtain the integral data bit “0” at the right bottom of FIG. 2, which integral data bit indicates that at least in one of the data buffer sections there is empty data buffer area for storing at least one data frame.

FIGS. 4 and 5 illustrate one exemplary way of calculating an explicit data buffer address number m of empty data buffer area (the corresponding data buffer section being capable of receiving further data, like at least one further data frame). FIGS. 4 and 5 thus illustrate how to calculate a data buffer address number of a data buffer section to which data frames to be stored next shall be transmitted for intermediate, temporary storage in the data buffer 4.

In FIGS. 4 and 5, those constructional elements (like latches, registers or flip-flops) usable for storing the data bits DB, DB′, . . . of the various levels of hierarchy L0, L1, L2, L3 may be constructed similar to those of FIG. 3. Furthermore, the AND-operations for combining two respective data bits of a pair of data bits (resulting in one or respective data bit of higher level of hierarchy L of an order n+1) is analogous to FIG. 3. However, in addition thereto, according to FIG. 4 further data bits (underlined in FIG. 4) are attributed to the data bits of the higher levels L1 to L3 in order to calculate a data buffer address number M to be used for storing subsequent data frames. In FIG. 4, each data bit DB′ (resulting from an AND-operation of two zero-order data bits DB) is accompanied by one respective additional data bit underlined and separated, by means of a comma, from the respective data bit DB′. These additional data bits are resulting from the respective right one of two data bits DB of a respective pair of data bits of the zero-order level of hierarchy L0. In particular, the data bit DB corresponding to the data buffer section having the least data buffer address number (of both respective data buffer addresses combined with one another) is used for being attributed to one respective data bit DB′ of the next higher level of hierarchy L1.

For instance, the data bit DB of the data buffer section with data buffer address number m=6 (which data bit is “1”) is attributed to the data bit DB′ in the first-order level of hierarchy L1 (which data bit DB′ is zero and is representing the result of the AND-operation of the data bits 0 and 1 of the data buffer sections with address numbers 6 and 7). Similarly, the data bits DB of the data buffer sections with address numbers 0, 2, 4 of the zero order level of hierarchy L0 are attributed to the respective data bit DB′ of the level of hierarchy L1. The attributed data bits are following after a respective comma in FIG. 4 and are underlined in FIG. 4. The underlinings thus indicate that the respective attributed data bit originates from the next lower level of hierarchy of the respective order (n−1). Pictorially speaking, in FIG. 4 each right data bit of a pair of data bits (to be combined with one another by an AND-operation) is shifted or propagated to the next higher level and attributed to the respective data bit DB′ representing the result of the respective AND-operation.

The data bits DB′ and DB″ of the levels of hierarchy L1, L2 are combined with one another by AND-operations (“&”) in analoguous way as in FIG. 3. However, in addition thereto, the data bits DB″, DB′″ of the levels of hierarchy L2, L3 are likewise accompanied by further data bits attributed thereto, the further data bits being also underlined in FIG. 4. As in the level of hierarchy L1, the accompanying, attributed data bits underlined are resulting from the respective right data bit of the next lower level of hierarchy, which data bit has been propagated or shifted to the next higher level of hierarchy. For instance, that data bit DB′ of the level L1, which indicates the result of AND-operation of the data bits DB of data buffer address numbers 4 and 5, is zero, as apparent from the second, non-underlined digit in the level L1. This data bit is propagated to the second order level of hierarchy L2 (digit “0” underlined) and is attributed to the data bit DB″ (which also is “0” but is not underlined), the data bit DB″ representing the result of the AND-operation of the both left, non-underlined data bits DB′ of the first order level of hierarchy L1.

Finally, the data bit DB′″ (“0”) of the ultimate, third order level of hierarchy L3 is accompanied by an additional data bit “1” attributed thereto. Compared to FIG. 3, in FIG. 4 the additional data bits attributed to the next higher order level of hierarchy (the attributed data bits being underlined in FIG. 4) are representing allocated address indices for calculating the next free data buffer address number M to be outputted by the data buffer control unit 25.

FIG. 4 further indicates how to calculate the next free data buffer address number M by means of the present algorithm. As indicated by the angled arrows in FIG. 4, the address number M is calculated by propagating, starting from the ultimate level of hierarchy L3, in reverse order top down to the zero-order level of hierarchy L0, along one particular path. This path results from the directions of top down propagation illustrated by the angled arrows illustrated in FIG. 4. Those underlined attributed data bits which are “1” indicate that the left, lower node of the schematic tree of FIG. 4 is chosen for propagation. In case of an attributed data bit which is “0”, the top down propagation to the righthand side in FIG. 4 is to be chosen. The path through the schematic tree of nodes of FIG. 4 in top down direction is indicated by the attributed data bits being underlined twice. In particular, starting with the ultimate level of hierarchy L3, the attributed data bit “1” underlined twice indicates propagation to the penultimate level of hierarchy L2 to the left side in FIG. 4, thereby arriving at data bit DB″ (“0”) accompanied by a further attributed data bit “0” underlined twice. This attributed data bit indicates further propagation to the first other level of hierarchy L1 to the right side in FIG. 4, thereby arriving at data bit DB′ accompanied by the attributed data bit “1” underlined twice. The top down propagation through the schematic tree described herein serves to calculate the next free address of one of the data buffer sections used for storing at least one subsequent data frame. In particular, along the nodes of the from-the-top-to-the-bottom path (taken from the route node in the ultimate level L3 back to the first-order level L1), for each non-underlined data bit at the respective node, a respective factor of 2ⁿ (n indicating the order of the next lower level of hierarchy from which the non-underlined data bit originates) is multiplied with the attributed data bit (underlined twice), thereby obtaining a respective product, the respective product representing the contribution of the corresponding level of hierarchy to the address number M to be calculated. Finally, the contributions or products of all respective levels of hierarchy L3 to L1 are added to one another, thereby yielding the address number M indicating the next free data buffer section to which at least one subsequent data frame is then transmitted for temporary storage.

These last steps of the above algorithm are more clearly illustrated in FIG. 5. Those attributed data bits following the top down path through the schematic tree and being underlined twice constitute the sequence of data bits “1-0-1”. These attributed data bits 1, 0 and 1 have originally been propagated upwardly from the respective next lower levels of hierarchy L0, L1 and L2. These levels of hierarchy of the order n=0, 1 and 2 are furthermore defining the weight of the respective attributed data bits. As indicated on the right side of FIG. 5, the attributed data bit “1” resulting from the original second order level of hierarchy L2 is multiplied with 2²,the exponent n=2 representing the order of the level of hierarchy L2. Similarly, the further attributed data bits “0” and “1” originating from the levels of hierarchy L1 and L0 of the order n=1 and n=0 are multiplied with 2¹ (for n=1) and 2⁰ (for n=0), respectively. Finally, the sum over the three levels of hierarchy is formed, thereby obtaining M=5 (by 1×2²+0×2¹+1×2⁰=4+0+1=5) indicating the first (and in this case lowest) address number m in which at least one further data frame is stored next. Accordingly, by means of the above algorithm a predefined way of calculating a next free data buffer address number is provided, the algorithm using data bits DB of a first order level of hierarchy L0, which data bits DB originally are only indicating whether there is empty storage capacity in the respective data buffer section 10. By combining the data bits DB and those of the higher order levels of hierarchy with one another as explained above, the data buffer address number M to be outputted by the data buffer control unit 25 can be calculated.

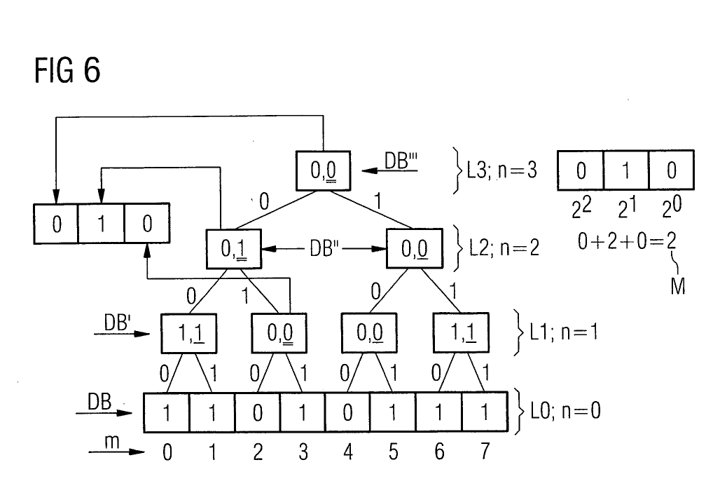

FIG. 6 illustrates an alternative embodiment for calculating the data buffer address number M of a next free data buffer section 10 capable of storing at least one data frame. In FIG. 6 the data buffer address numbers m are arranged in numerical order from the left to the right side and in the example of FIG. 6 only the data buffer sections having the address number 2 and 4 comprise empty data buffer area. In the example of FIG. 6 the data bits non-underlined and arranged within the higher order levels of hierarchy L1, L2, L3 are representing the result of the AND-operations performed. In the example of FIG. 6 the respective left data bit of any level of hierarchy is attributed to the data bit of the next higher level of hierarchy. For instance, the underlined data bit “1” attributed to the data bit DB′ “1” obtained by combining the data bits of address numbers m of 0 and 1 is propagated to the second order level of hierarchy L2 and attributed to the data bit DB″ “0” of the level L2. In the example of FIG. 6, an attributed data bit underlined, which is zero (“0”) indicates top down reverse propagation to the next lower level of hierarchy along the lefthand direction wherein an attributed data bit of “1” indicates top down propagation along the righthand direction in FIG. 6. Accordingly, the sequence of data bits “0 1 0” is obtained which accordingly, when multiplying each of these three data bits with 2ⁿ (n resulting the original order of those respective level of hierarchy) and forming in a sum of these products, a result in M=2, which is the smallest address number m of a data buffer section 10 capable of storing at least one further data frame.

As already mentioned above, AND-gates capable of performing the AND-operations may be provided and arranged as illustrated in FIGS. 2 to 6. However, the arrangements indicated by FIGS. 2 to 6 need not physically be present within the data buffer control unit 25 since, alternatively, any other internal design of the data buffer control unit 25 resulting in the same logic result for the calculated address number M may be realized. For instance, AND-gates may be replaced by any combinations of one or more of the group of AND-, NAND-, OR- or NOR-gates, for instance. Of course, the internal design of the data buffer control unit 25 may be designed with AND-gates exclusively and may be designed as illustrated in FIGS. 3 to 5, thereby representing one possible embodiment of the invention.

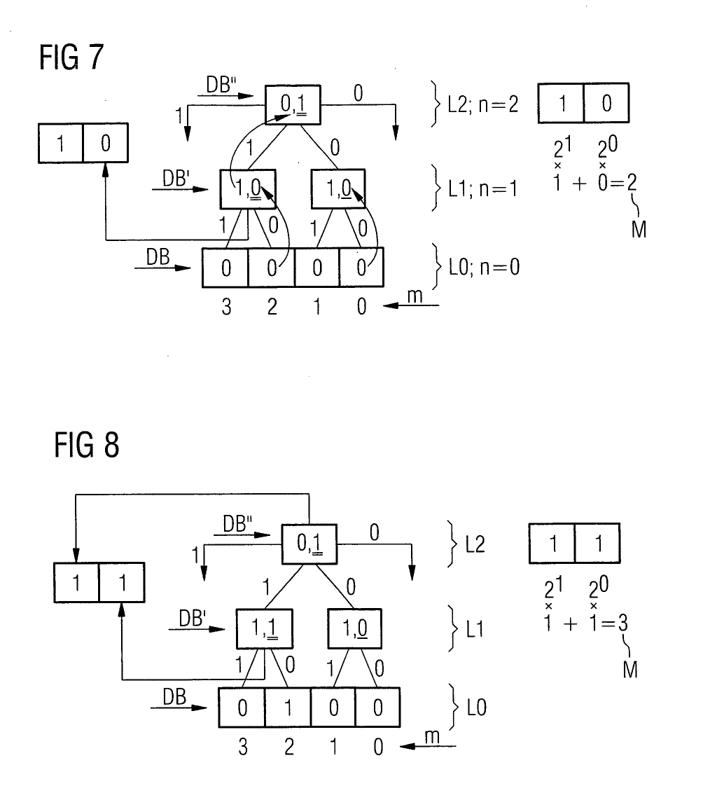

FIGS. 7 to 10 illustrate a further embodiment of the present invention. In the embodiment of these figures, data frames are written into the data buffer sections 10 in a different order than a numerical order. In the example of FIGS. 7 to 10, the data buffer sections 10 in the order of the data buffer address numbers 2, 3, 0, 1 are used for storing the next data frames, depending on which of the addresses 2, 3, 0, 1 (beginning with address m=2) comprises empty data buffer area.

In the example of FIGS. 7 to 10 a data buffer comprising only four data buffer sections (having address numbers 0, 1, 2, 3) is used for easier explanation. Furthermore, in the embodiment of FIGS. 7 to 10, the respective right data bit DB of a pair of data bits DB combined with one another is propagated to the data bit of a second order level of hierarchy L1 (that is attributed to a data bit DB′) whereas the left data bit DB′ of the level of hierarchy L1 is attributed to the data bit DB″ of the ultimate level L2. Furthermore, all operations used for combining two respective data bits to one respective data bit of a higher level of hierarchy are NAND-operations rather than AND-operations.

As apparent from FIG. 7, the data bits of the zero-order level of hierarchy L0 are combined with one another in pairs so as to obtain one respective data bit DB′ of the first order level of hierarchy L1. In FIG. 7 all data bits DB of the address number n=0, 1, 2, 3 are zero (“0”).

The data bits DB′ of the first order level of hierarchy L1 are further combined with one another by NAND-operations. Thereby two non-underlined data bits DB′ are combined to one data bit DB′ non-underlined of the ultimate level of hierarchy L2. For attributing one of the non-underlined data bits DB′ of the level L1 to the data bit DB″, the data bit DB′ illustrated left in FIG. 7 is employed, thereby resulting in the underlined attributed data bit “1” besides the data bit DB″ of “0” in the ultimate level L2.

In FIGS. 7 to 10 an attributed data bit being “1” indicates top down propagation to the next lower level of hierarchy along the lefthand direction. Accordingly, starting from the attributed data bit “1” underlined twice in the ultimate level L2, the next attributed data bit is the attributed left twofold underlined “0” of the level L1. Accordingly, the data buffer address number to be calculated is the result of the sum of products of the respective attributed data bit times 2ⁿ; n being the order of the respective level of hierarchy. Since the underlined “1” attributed to the data bit DB″ of “0” of the level L2 results from upwards propagation of the left data bit DB′ of “1” of the first order level L1, the exponent n=1 is used, multiplied with the factor of DB″ (that is of “0”) of the ultimate level L2. In an analogous way, the further contribution to M is given by the product of attributed data bit DB of “0” (underlined twice) multiplied with 2⁰; n=0 being the order of the level of hierarchy L0. Accordingly, as illustrated right in FIG. 7, the evaluated next free data buffer address number of (2¹×1)+(2⁰×0)=2. Accordingly, since in the example of FIG. 7 all data bits DB are “0”, the address number m=2 is the first addressed to be used for storing further data frames.

As apparent from FIG. 8, in case that the data buffer section 10 of the address number of m=2 is occupied (as indicated by data bit DB of “1” assigned to m=2), the result of calculation of the address number M to be outputted by the data buffer control unit 25 is “3”. Accordingly, the predefined order of address numbers m to be used storing additional data is such that the data buffer section having the address number m=3 is used next in case that the data buffer section of address number m=2 is already occupied.

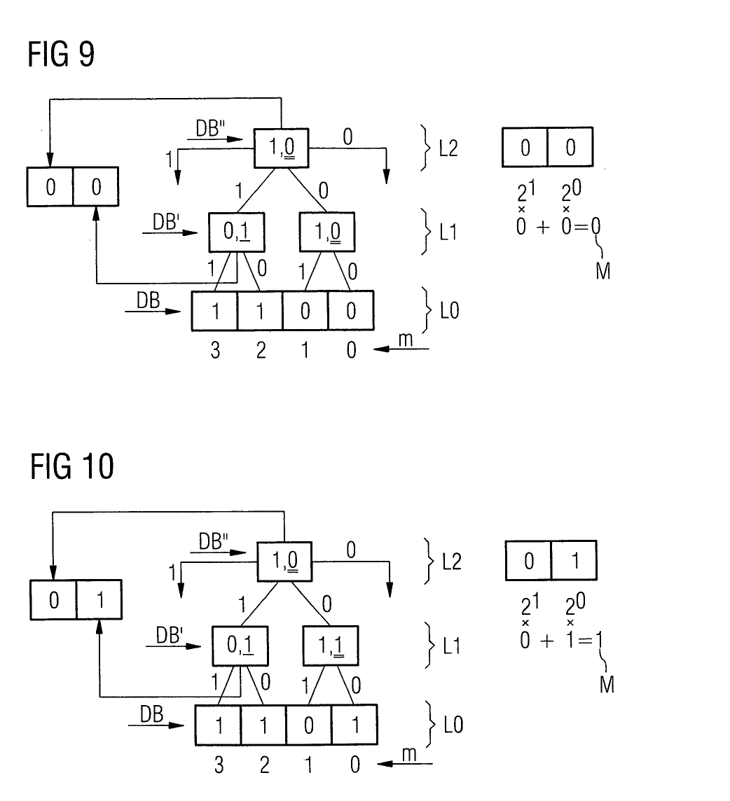

Correspondingly, if also the data buffer section of the address m=3 is occupied (FIG. 9), the calculation of M performed in analoguous way as in FIGS. 7 and 8 leads to the result M=0. In case that even the data buffer section of address number m=0 is occupied (of FIG. 10), the result of the address number calculation is M=1. Accordingly, though the memory addresses m=0, 1, 2, 3 are in numerical order, the predefined order of data buffer address numbers temporarily storing additional data frames is “2, 3, 0, 1”, which is different from the usual numerical order of “0, 1, 2, 3”. Accordingly, any arbitrarily predefined order can be used for completely designing the algorithm and the internal construction of the data buffer control unit 25 serving to output the respective data buffer address number for storage of data frames. As in the previous figures, this embodiment does not require the explicit arrangement of the gates (like NAND-gates) corresponding to FIGS. 7 to 10 for performing the same mathematical algorithm resulting in calculation of the data buffer address number of a data buffer section to which one or more data frames are transmitted next for temporary storage within the data buffer.

What is claimed is:

1. An integrated memory device comprising:
a memory core having a plurality of memory cells;
a group of terminals for communication between the memory device and an external electronic device;
a data buffer for temporary storage of data, the data buffer being coupled to the group of terminals and to the memory core, the data buffer comprising a plurality of data buffer sections, each data buffer section being capable of temporarily storing at least one data frame and being accessible by a respective data buffer address; and
a data buffer control unit;
wherein the memory device is constructed to generate, for each data buffer section, at least one data bit assigned to the respective data buffer section, the data bit indicating whether the respective data buffer section comprises empty data buffer area for storing at least one data frame or whether the respective data buffer section is occupied; and
wherein the data buffer control unit is constructed to calculate, using the data bits assigned to the data buffer sections, a data buffer address of a data buffer section to which data frames are transmitted for being stored temporarily.

2. The memory device of claim 1, wherein the memory device is constructed to write data frames into those data buffer sections that correspond to a data buffer address calculated by the data buffer control unit using the data bits.

3. The memory device of claim 1, wherein the data buffer control unit combines data bits of all data buffer sections when calculating the data buffer address in which data frames are to be stored.

4. The memory device of claim 1, wherein the memory device, prior to writing a data frame into the data buffer, instructs the data buffer control unit to calculate a data buffer address of a data buffer section to which a data frame is transmitted.

5. The memory device of claim 1, wherein each data buffer section is capable of storing a plurality of data frames.

6. The memory device of claim 1, wherein the data buffer comprises data buffer sections corresponding to data buffer address numbers forming a predefined order, the predefined order of the data buffer address numbers ranging from a first data buffer address number to a last data buffer address number or vice versa.

7. The memory device of claim 6, wherein the data buffer control unit combines the data bits such that a smallest or a largest data buffer address number that corresponds to a data buffer section not yet completely occupied with data frames is calculated.

8. The memory device of claim 7, wherein the memory device, for temporarily storing a data frame in the data buffer, transmits the data frame to that data buffer section that corresponds to the smallest data buffer address number.

9. The memory device of claim 7, wherein the memory device, for temporarily storing a data frame in the data buffer, transmits the data frame to that data buffer section that corresponds to the largest data buffer address number.

10. The memory device of claim 1, wherein an input of the data buffer is coupled to the plurality of terminals and wherein an output of the data buffer is connected to the memory core.

11. The memory device of claim 10, wherein the memory device writes data frames received via a plurality of terminals into the data buffer.

12. The memory device of claim 10, wherein the memory device transmits data to be stored in the memory core from the data buffer to the memory core.

13. The memory device of claim 1, wherein an input of the data buffer is coupled to the memory core and wherein an output of the data buffer is connected to the plurality of terminals.

14. The memory device of claim 1, wherein the memory device further comprises a data frame decoder for decoding data frames received via the plurality of terminals.

15. The memory device of claim 1, wherein the data buffer control unit comprises an address pointer supplying data buffer addresses calculated by the data buffer control unit using the data bits assigned to the data buffer sections.

16. The memory device of claim 1, wherein the memory device reads all data frames stored in a particular data buffer section when performing an operation of writing of data from a data buffer address into the memory core.

17. The memory device of claim 1, wherein the memory device comprises a volatile memory device.

18. The memory device of claim 17, wherein the memory device comprises a dynamic random access memory device.

19. The memory device of claim 18, wherein the memory cells each comprise a selection transistor and a storage capacitor.

20. The memory device of claim 1, wherein the memory cells are coupled to bitlines and wordlines.

21. The memory device of claim 1, wherein
the data buffer addresses are represented by data buffer address numbers, the data buffer address numbers of the data buffer sections constituting a predefined order of data buffer address numbers; and
wherein the memory device combines the data bits with one another, thereby calculating a data buffer address number that represents, within the predefined order of data buffer address numbers, a first data buffer address number corresponding to a data buffer section that comprises empty data buffer area for storing at least one data frame.

22. The memory device of claim 21, wherein the memory device combines the data bits with one another by means of Boolean operators.

23. The memory device of claim 21, wherein the data bits assigned to the data buffer sections are constituting a level of hierarchy of the order 0, and wherein two respective data bits of the level of hierarchy of the order 0 are combined with one another, thereby obtaining one respective data bit of a level of hierarchy of the order 1.

24. The memory device of claim 21, wherein the memory device, for calculating the data buffer address number consecutively combines the data bits of same, further levels of hierarchy, so as to obtain data bits of further levels of hierarchy, thereby combining two data bits of the level of hierarchy of the order n to obtain one data bit of a level of hierarchy of the order n+1.

25. The memory device of claim 24, wherein the memory device, for calculating a data buffer address number, combines two data bits of a penultimate level of hierarchy to obtain one data bit of an ultimate level of hierarchy of the order N.

26. The memory device of claim 21, wherein the memory device assigns a plurality of N data buffer address numbers to the data buffer addresses of a plurality of N data buffer sections and wherein the memory device combines the data bits of the level of hierarchy of the order 0 consecutively, thereby generating data bits of N levels of hierarchy.

27. The memory device of claim 21, wherein the data buffer address numbers constitute a numerical order of data buffer address numbers.

28. The memory device of claim 27, wherein the numerical order of data buffer address numbers ranging between a smallest data buffer address number and a largest data buffer address number.

29. The memory device of claim 28, wherein the numerical order of data buffer address numbers start with the smallest data buffer address number and ends with the largest data buffer address number or vice versa.

30. The memory device of claim 21, wherein the memory device, for calculating a data buffer address number, attributes, to one respective data bit of each level of hierarchy of an order higher than 0, one of the data bits having been combined, thereby resulting in the respective data bit of the higher level of hierarchy, wherein the memory device for each attribution of a particular level of hierarchy uses that one of the two combined data bits of the lower level of hierarchy that corresponds to a data buffer address number occurring first, within the predefined order of data buffer address numbers, compared to the data buffer address number represented by the other one of the two combined data bits.

31. The memory device of claim 30, wherein, for each attribution to a data bit of a level of hierarchy of an order n+1, that data bit of the two respective data bits of the level of hierarchy of the order n is attributed that corresponds to the smaller data buffer address number compared to the data buffer address number of the other data bit combined therewith.

32. The memory device of claim 30, wherein, for each attribution to a data bit of a level of hierarchy of an order n+1, that data bit of the two respective data bits of the level of hierarchy of the order n is attributed that corresponds to the larger data buffer address number compared to the data buffer address number of the other data bit combined therewith.

33. The memory device of claim 30, wherein the memory device assigns to each level of hierarchy of an order n of a factor represented by 2ⁿ.

34. The memory device of claim 33, wherein the memory device obtains the data buffer address number to be calculated by multiplying each factor 2ⁿ assigned to a level of hierarchy of the order n with the data bit assigned to one of the data bits of the level of hierarchy of the order n, thereby yielding a respective product, and by forming the sum of the products for plural levels of hierarchy.

35. The memory device of claim 33, wherein in each level of hierarchy the factor of 2ⁿ is multiplied with only one attributed data bit, thereby obtaining a contribution of the respective level of hierarchy to the data buffer address number to be calculated, and wherein the sum over contributions of plural levels of hierarchy is formed, thereby resulting in the data bufer address number to be calculated.

36. The memory device of claim 35, wherein forming the sum to obtain the data buffer address number to be calculated is started with an ultimate level of hierarchy of the order N and wherein the data bit attributed to the data bit of the ultimate level of hierarchy and resulting from the penultimate level of hierarchy is used for selecting the attributed data bit of which one of the data bits of the penultimate level of hierarchy of the order N−1 is used for further calculating the data buffer address number to be calculated.

37. The memory device of claim 33, wherein forming the sum to obtain the data buffer address number to be calculated is continued with consecutively selecting one respective data bit of a next lower level of hierarchy of an order n−1, the selection depending on the numerical value of the data bit attributed to a data bit of the respective, next higher level of hierarchy.

38. The memory device of claim 37, wherein, for plural levels of hierarchy, a respective factor of 2ⁿ is multiplied with a respective attributed data bit, thereby obtaining products for the respective levels of hierarchy, and wherein the products are added to one another, thereby obtaining the data buffer address number assigned to the data buffer section capable of storing at least one data frame.

39. A method of operating a memory device comprising a data buffer having a plurality of data buffer sections accessible by data buffer addresses, the method comprising:
assigning to each data buffer section a data buffer address, the data buffer addresses being represented by data buffer address numbers and the data buffer address numbers of the data buffer sections constituting a predefined order of data buffer address numbers;
generating for each data buffer section at least one data bit assigned to the respective data buffer section, the data bits indicating whether the respective data buffer section comprises empty data buffer area for storing at least one data frame or whether the respective data buffer section is occupied; and
combining the data bits with one another, thereby calculating a data buffer address number that represents, within the predefined order of data buffer address numbers, a first data buffer address number corresponding to a data buffer section that comprises empty data buffer area for storing at least one data frame.

40. The method of claim 39, wherein the data bits are combined with one another by means of Boolean operators.

41. The method of claim 39, wherein the data bits assigned to the data buffer sections are constitute a level of hierarchy of the order 0, and wherein two respective data bits of the level of hierarchy of the order 0 are combined with one another, thereby obtaining one respective data bit of a level of hierarchy of the order 1.

42. The method of claim 41, wherein calculating the data buffer address number comprises consecutively combining the data bits of same, further levels of hierarchy, so as to obtain data bits of further levels of hierarchy, thereby combining two data bits of the level of hierarchy of the order n to obtain one data bit of a level of hierarchy of the order n+1.

43. The method of claim 39, wherein calculating a data buffer address number includes combining two data bits of a penultimate level of hierarchy to obtain one data bit of an ultimate level of hierarchy of the order N.

44. The method of claim 39, wherein a plurality of N data buffer address numbers is assigned to the data buffer addresses of a plurality of N data buffer sections and wherein combining the data bits of the level of hierarchy of the order 0 are consecutively combined, thereby generating data bits of N levels of hierarchy.

45. The method of claim 39, wherein the data buffer address numbers constitute a numerical order of data buffer address numbers.

46. The method of claim 45, wherein the numerical order of data buffer address numbers range between a smallest data buffer address number and a largest data buffer address number.

47. The method of claim 46, wherein the numerical order of data buffer address numbers starts with the smallest data buffer address number and ends with the largest data buffer address number or vice versa.

48. The method of claim 39, wherein calculating a data buffer address number further includes attributing, to one respective data bit of each level of hierarchy of an order higher than 0, one of the data bits having been combined, thereby resulting in the respective data bit of the higher level of hierarchy, wherein for each attribution of a particular level of hierarchy that one of the two combined data bits of the lower level of hierarchy is used that corresponds to a data buffer address number occurring first, within the predefined order of data buffer address numbers, compared to the data buffer address number represented by the other one of the two combined data bits.

49. The method of claim 48, wherein, for each attribution to a data bit of a level of hierarchy of an order n+1, that data bit of the two respective data bits of the level of hierarchy of the order is attributed that corresponds to the smaller data buffer address number compared to the data buffer address number of the other data bit combined therewith.

50. The method of claim 48, wherein, for each attribution to a data bit of a level of hierarchy of an order n+1, that data bit of the two respective data bits of the level of hierarchy of the order n is attributed that corresponds to the larger data buffer address number compared to the data buffer address number of the other data bit combined therewith.

51. The method of claim 48, wherein to each level of hierarchy of an order n of a factor represented by 2ⁿ is assigned.

52. The method of claim 51, wherein the data buffer address number to be calculated is obtained by multiplying each factor 2ⁿ assigned to a level of hierarchy of the order n with the data bit assigned to one of the data bits of the level of hierarchy of the order n, thereby obtaining a respective product, and by forming the sum of the products for plural levels of hierarchy.

53. The method of claim 51, wherein in each level of hierarchy the factor of 2ⁿ is multiplied with only one attributed data bit, thereby obtaining a contribution of the respective level of hierarchy to the data buffer address number to be calculated, and wherein the sum over contributions of plural levels of hierarchy is formed, thereby resulting in the data buffer address number to be calculated.

54. The method of claim 39, wherein forming the sum to obtain the data buffer address number to be calculated starts with an ultimate level of hierarchy of the order N and wherein the data bit attributed to the data bit of the ultimate level of hierarchy and resulting from the penultimate level of hierarchy is used for selecting the attributed data bit of which one of the data bits of the penultimate level of hierarchy of the order N−1 is used for further calculating the data buffer address number to be calculated.

55. The method of claim 51, wherein forming the sum to obtain the data buffer address number to be calculated is continued with consecutively selecting one respective data bit of a next lower level of hierarchy of an order n−1, the selection depending on the numerical value of the data bit attributed to a data bit of the respective, next higher level of hierarchy.

56. The method of claim 55, wherein, for plural levels of hierarchy a respective factor of 2ⁿ is multiplied with a respective attributed data bit, thereby obtaining products for the respective levels of hierarchy, and wherein the products are added to one another, thereby obtaining the data buffer address number assigned to the data buffer section capable of storing at least one data frame.

57. The method of claim 39, wherein the Boolean operators are one of AND-operators, NAND-operators, OR-operators or NOR-operators.

58. The method of claim 57, wherein the Boolean operators are AND-operators.
